(19) United States
(12) Patent Application Publication
(10) Pub. No.: US 2015/0227231 A1
(43) Pub. Date: Aug. 13, 2015

(54) Virtual Transparent Display

(71) Applicant: Microsoft Corporation, Redmond, WA (US)

(72) Inventor: Liying Chen, Redmond, WA (US)

(73) Assignee: Microsoft Corporation, Redmond, WA (US)

(21) Appl. No.: 14/178,731

(22) Filed: Feb. 12, 2014

(51) Int. Cl. G06F 3/044; G06F 3/0484; G06F 3/0481; G06F 3/0488

(52) U.S. Cl. CPC G06F 3/044; G06F 3/04886; G06F 3/04842; G06F 3/04817

(57) ABSTRACT

Virtual transparent display techniques are described. In one or more implementations, an apparatus includes a housing and a display device viewable by and secured to a first side of the housing. The apparatus also includes one or more sensors configured to detect proximity of an object to a second side of the housing that opposes the first side of the housing and one or more modules implemented at least partially in hardware, the one or more modules configured to cause output of a representation on the display device of the object detected by the one or more sensors.

### BACKGROUND

Computing devices may be configured for use in a wide variety of environments. Indeed, one such configuration of the computing device is arranged to support mobile use, such as a mobile phone, tablet computer, portable gaming device, portable music device, and so on that is configured to be held by one or more hands of a user.

Because of the relatively small form factor of the mobile computing device, however, conventional techniques that are utilized to support functionality in interacting with the computing device may be limited. For example, conventional virtual keyboards are typically displayed on a display device of the computing device and support interaction through touchscreen functionality.

Consequently, a size of the virtual keyboard may be limited by a display size of the display device. Further, display of the virtual keyboard may also limit an amount of display area of the display device that is available for other uses, such as to display text and user interface elements with which a user interacts. Although conventional techniques have been developed to support “off screen” inputs, these inputs typically supply limited feedback and therefore may be frustrating to a user.

### SUMMARY

Virtual transparent display techniques are described. In one or more implementations, an apparatus includes a housing and a display device viewable by and secured to a first side of the housing. The apparatus also includes one or more sensors configured to detect proximity of an object to a second side of the housing that opposes the first side of the housing and one or more modules implemented at least partially in hardware, the one or more modules configured to cause output of a representation on the display device of the object detected by the one or more sensors.

In one or more implementations, images are captured of a physical environment disposed at a rear of a housing that includes a display device. Proximity is detected of one or more objects disposed adjacent to the rear of the housing of the display device. A user interface is configured for display by the display device. The user interface includes one or more user interface elements that are configured to support user interaction to initiate one or more operations of a computing device, representations of the physical environment generated from the captured images, and representations the one or more objects in relation to the one or more user interface elements that are displayed on the display device that support user interaction through the detection of the proximity of the one or more objects.

In one or more implementations, an apparatus includes a housing, a display device viewable by and secured to a first side of the housing, an image capture system including an optical wedge configured to capture images of a physical environment disposed on a second side of the housing that is opposite to the first side of the housing, and one or more modules implemented at least partially in hardware. The one or more modules are configured to cause output of a virtual transparent display on the display device that includes one or more user interface elements that are configured to support user interaction to initiate one or more operations of a computing device and a representation of the physical environment generated form the captured images.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ virtual transparent display techniques as described herein.

FIG. 2 depicts a system in an example implementation showing a computing device of FIG. 1 in greater detail as including sensors configured to detect proximity of an object.

FIGS. 3 and 4 depict example implementations of a user interface output by a display device that includes user interface elements and representations of objects detected by object detection sensors of FIG. 2.

FIG. 5 depicts a system in an example implementation showing a computing device of FIG. 1 in greater detail as including sensors configured to detect a physical environment of the computing device.

FIG. 6 depicts an example image capture system that includes an optical wedge and that is configured to detect a physical environment of FIG. 1 of the computing device.

FIG. 7 depicts an example implementation in which a user interface displayed by a display device of a computing device includes representations of objects detected as proximal to the computing device as well as representations of the physical environment that includes the computing device.

FIG. 8 depicts an example implementation showing a display device of FIG. 1 as being configured to rest on a surface horizontally, the device supporting virtual transparent display functionality of FIGS. 2-7.

FIG. 9 is a flow diagram depicting a procedure in an example implementation in which a virtual transparent display is generated that includes user interface elements, a representation of an object detected as proximal to a display device, and a representation of a physical environment, in which, the display device is disposed.

FIG. 10 illustrates an example system including various components of an example device that can be implemented as any type of computing device as described with reference to FIGS. 1-9 to implement embodiments of the techniques described herein.

### DETAILED DESCRIPTION

Overview

Mobile computing devices, as well as other configurations, may be limited in ways in which a user may interact with the device based on the configuration. Oftentimes, this is due to a lack of feedback provided by a user to support interaction with an input device, intrusion of the input device on other functionality of the computing device, and so on.

For example, a user may interact with a virtual keyboard displayed on a display device of a mobile computing device such as a mobile phone, tablet computer, and so on. In these configurations, however, the virtual keyboard is typically opaque and consumes more than half of an available display area of the display device. Additionally, a user's hands may occlude other displayed content and if the user is holding the mobile computing device, the user typically has use of only two thumbs to type because the rest of the user's fingers are used to grasp and hold the device.

Virtual transparent display techniques are described. In one or more implementations, sensors are disposed on a rear side of a computing device that are configured to detect proximity of an object, e.g., touch, hover, and so on. In this way, the user may interact with these sensors and thus not consume a display area of the display device. Further, feedback may be provided in the display device using a representation of the detection of the object at corresponding locations on the display device. For example, a “ghosted” image of the fingers of a user's hand that are positioned at a rear of the device may be displayed in a user interface on the display device. In this way, a user may be provided with feedback that may support intuitive interaction with user interface elements displayed in the user interface, e.g., keys of a keyboard, icons, tiles, animations, drawings, and so on. Thus, in this example a virtual transparent display is provided to give an appearance that users are “looking through” the display device to view their fingers.

Additionally, the virtual transparent display may also be configured to output representations of a physical environment disposed at a rear of the device. For example, images may be captured of the physical environment, e.g., through use of an optical wedge. The images may then be utilized to create a representation of the physical environment that mimics the physical environment such that the computing device acts like a transparent window. User interface elements may also be displayed such that a user may interact both with a front side (e.g., touchscreen functionality) and back side of the device. Thus, in this example a virtual transparent display is provided to give an appearance that the display device is a transparent window that may include user interface elements. A variety of other examples are also contemplated, further discussion of which may be found in relation to the following sections.

In the following discussion, an example environment is first described that may employ the virtual transparent display techniques described herein. Example procedures are then described which may be performed in the example environment as well as other environments. Consequently, performance of the example procedures is not limited to the example environment and the example environment is not limited to performance of the example procedures.

Example Environment

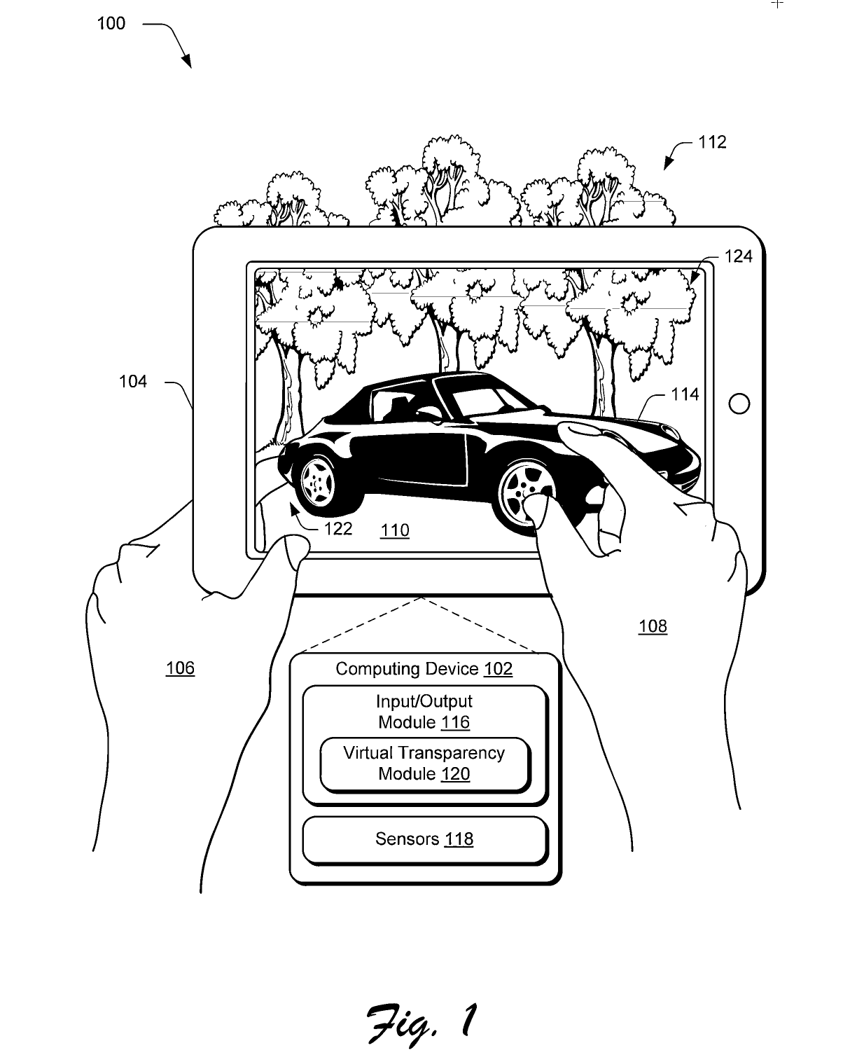

FIG. 1 is an illustration of an environment 100 in an example implementation that is operable to employ virtual transparent display techniques as described herein. The illustrated environment 100 includes a computing device 102, which may be configured in a variety of ways. For example, the computing device 102 is illustrated as having a mobile computing device configuration, e.g., a tablet computer, a mobile phone, portable game device, and so forth. The computing device employs a housing 104 that is configured in a handheld form factor to be held by one or more hands 106, 108 of a user as illustrated such that a user may view a display device 110 that is secured to the housing 104. As depicted, a user interface is displayed that includes a representation of a physical surroundings 112 of the computing device and a user interface element of a car 114 although other user interface elements are also contemplated as further described below.

A wide variety of other form factors are also contemplated, such as computer and television form factors as described in relation to FIG. 10. As such, the computing device 102 may range from full resource devices with substantial memory and processor resources (e.g., personal computers, game consoles) to low-resource devices with limited memory and/or processing resources (e.g., traditional televisions, net books). Additionally, although a single computing device 102 is shown, the computing device 102 may be representative of a plurality of different devices, such as a user-wearable helmet or glasses and game console, a remote control having a display and set-top box combination, a tablet and magnetically attachable keyboard, and so on.

The computing device 102 also includes an input/output module 116 in this example. The input/output module 116 is representative of functionality relating to detection and processing of inputs and outputs of the computing device 102. For example, the input/output module 116 may be configured to receive inputs from a keyboard, mouse, to recognize gestures and cause operations to be performed that correspond to the gestures, and so on. The inputs may be identified by the input/output module 116 in a variety of different ways.

For example, the input/output module 116 may be configured to recognize an input received via sensors 118 and process the input to perform a variety of different functions, which may be representative of a single set of multiple sets and types of sensors. Accordingly, the sensors 118 may be configured in a variety of different ways. The sensors 118, for instance, may be configured to support touchscreen functionality of a display device 110 to detect proximity of an object, such as a finger of a user's hand 108 as proximal to the display device 110 of the computing device 102, from a stylus, and so on. The input may take a variety of different forms, such as to recognize movement of the finger of the user's hand 108 across the display device 110, such as a tap on the car 114 in the user interface as illustrated by a finger of the user's hand 108, drawing of a line, and so on.

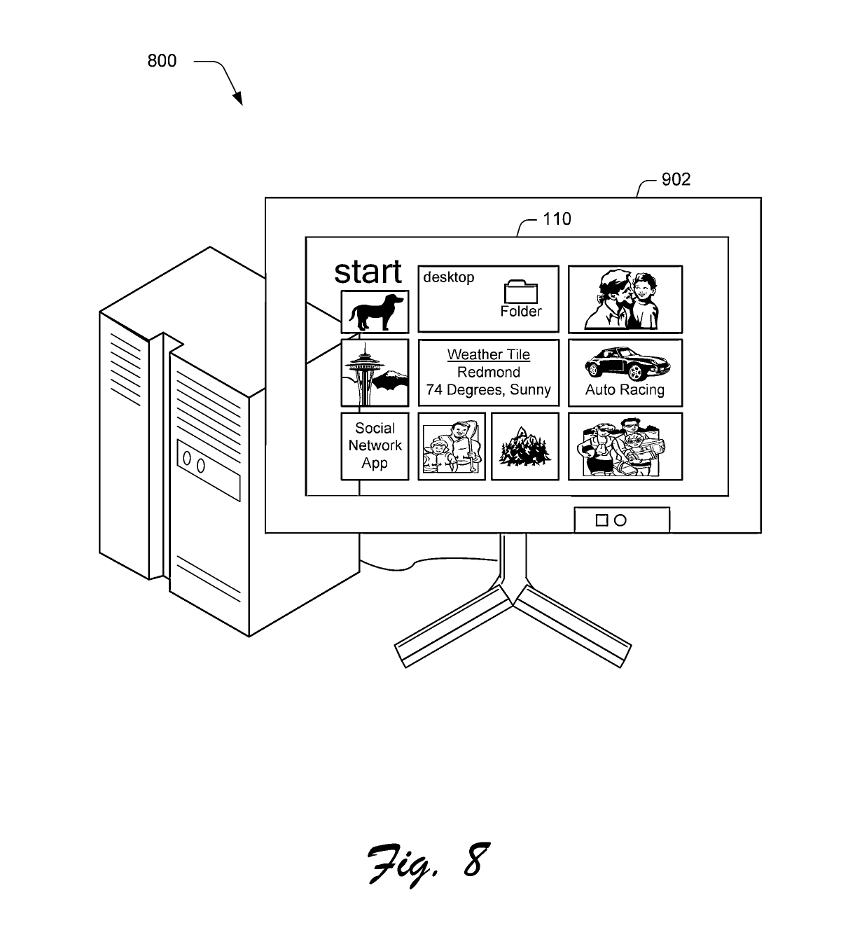

The sensors 118 may also be configured to detect inputs “outside” the display device 110. The sensors 118, for instance, may be disposed on a rear side of the housing that is opposite to that of the display device 110. The sensors 118, when in this configuration, may also be configured to detect proximity of an object, such as a finger of the user's hand 106 as disposed at a rear of the housing 104 of the computing device 102. This may be performed to support a variety of different input functionality, such as to interact with one or more user interface elements displayed by the display device 110, provide inputs (e.g., via a virtual keyboard implementation as shown in FIG. 7), and so on.

To aide a user's interaction with the sensors disposed as the rear of the device, the input/output module 116 may include a virtual transparency module 120. The virtual transparency module 120 is representative of functionality to configure a user interface that is displayed by the display device 110 to include representations based on inputs provided by sensors 118. The sensors 118, for instance, may be configured as object detection sensors that are configured to detect objects at a rear of the computing device 102. This may include detecting proximity of one or more objects (e.g., a finger of the user's hand 106), e.g., as a touch input. The virtual transparency module 120 may then configure the user interface, based on this detection, to include a representation 122 of the detected object.

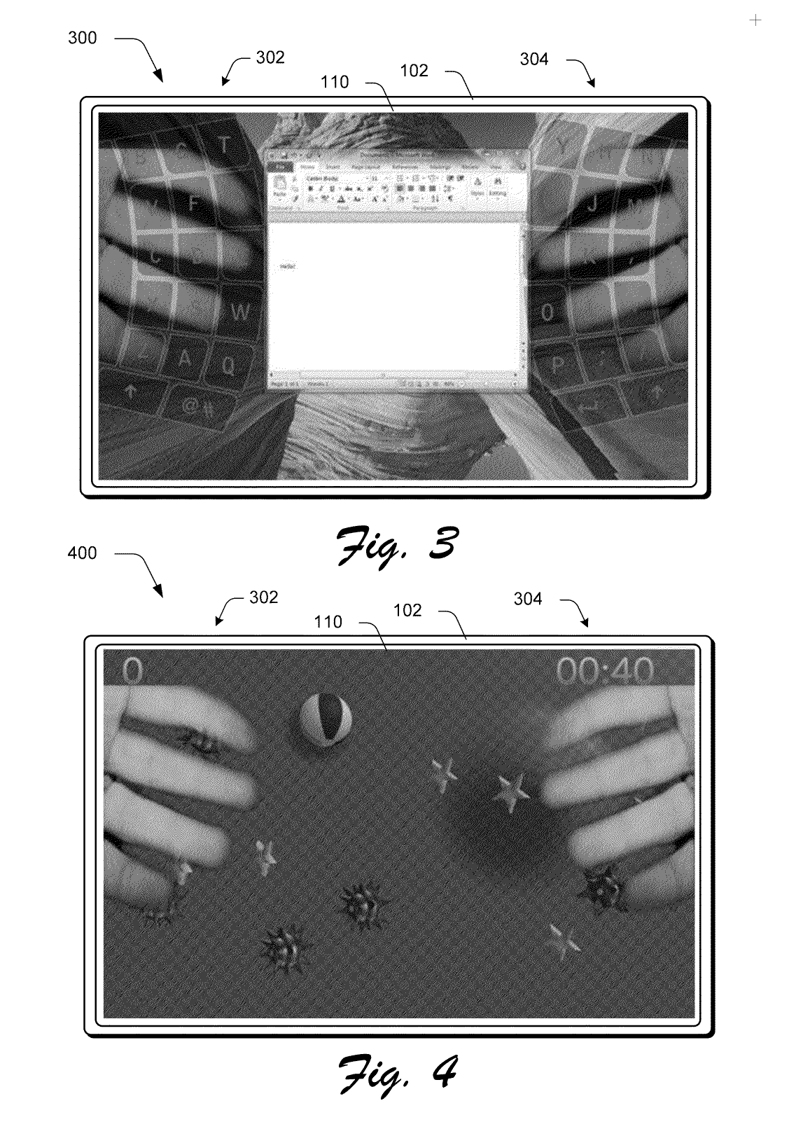

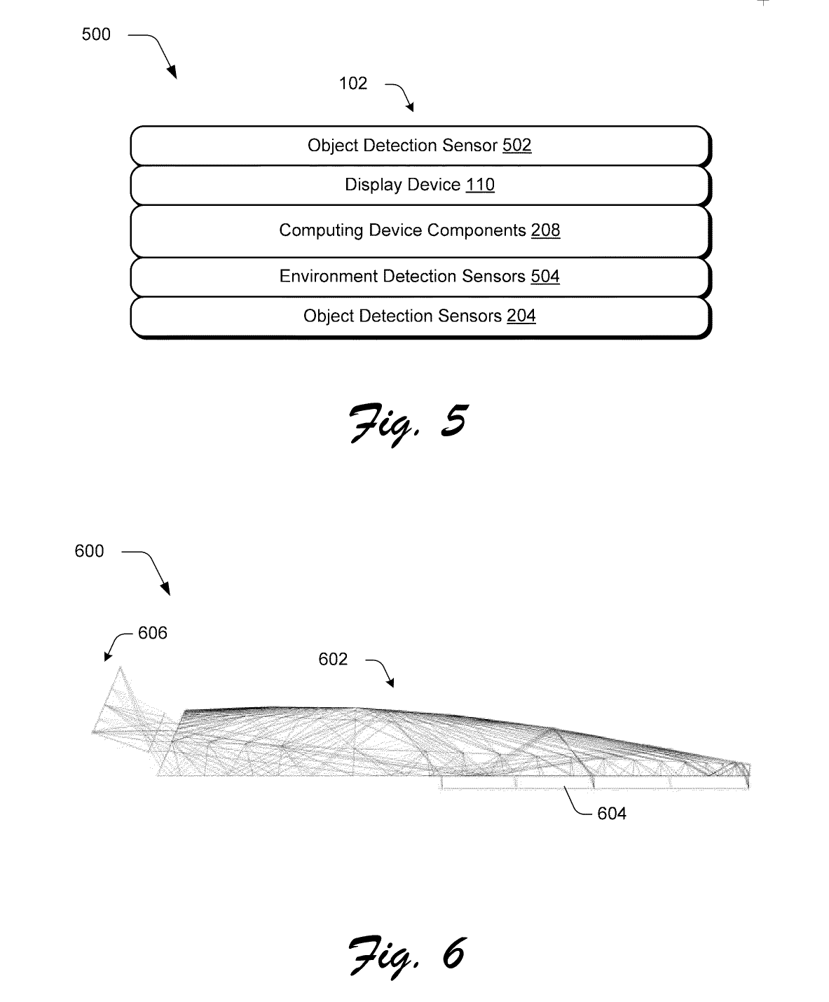

In the illustrated example, the representation 122 is configured to mimic the finger of the user's hand 106 and is updated in real time such that a user may interact with the computing device 102 as if the display device 110 was configured as a transparent window. Thus, configuration of the sensors 118 as object detection sensors in this instance may be leveraged by the virtual transparency module 120 to provide a representation of the object in the user interface displayed by the display device 110. This may be utilized to support a variety of user interaction, such as to interact with user interface elements displayed by the display device as shown in FIGS. 3 and 4.

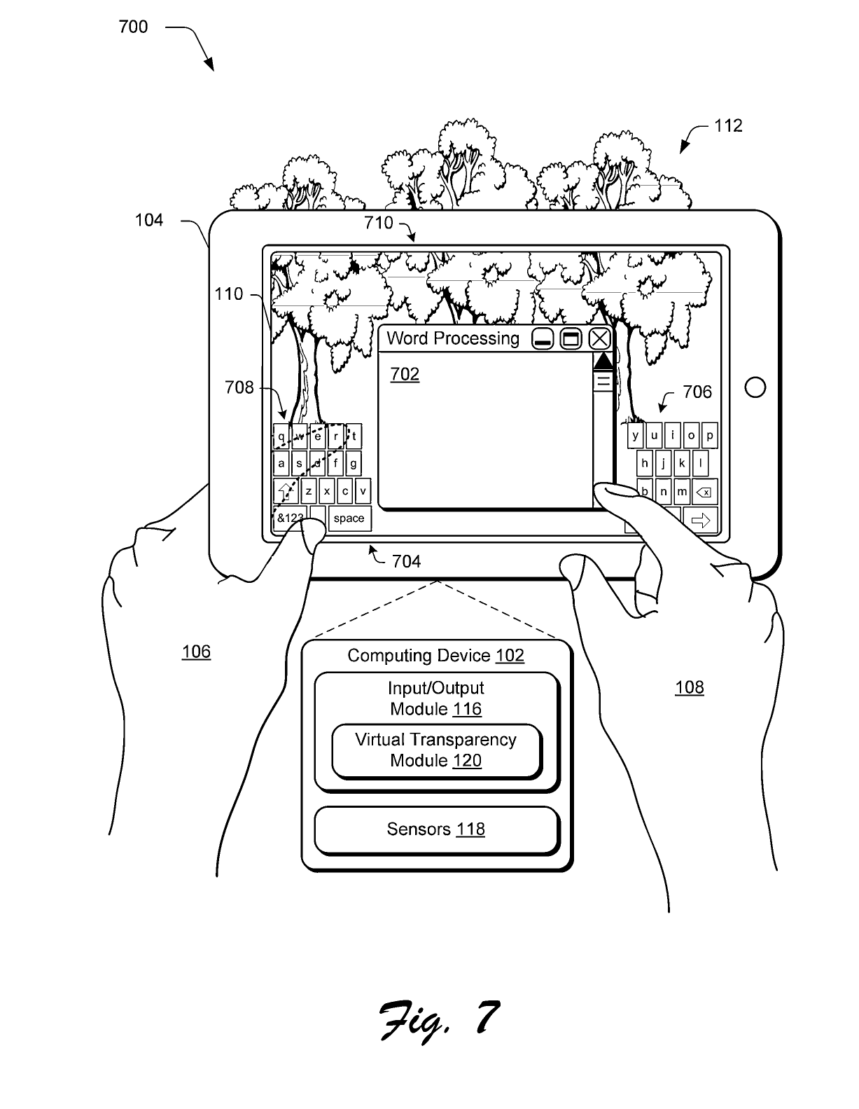

The sensors 118 may also be configured as environment detection sensors that are configured to detect the physical surroundings 112 of the computing device 102. The sensors 118, for instance, may be configured as part of an image capture system (e.g., one or more cameras) that captures images of the physical surroundings 112 disposed at a rear of the housing of the computing device 102, such as an optical wedge as described in relation to FIG. 6. These images may then be processed by the virtual transparency module 120 to generate a representation 124 of the physical surroundings 112 of the computing device 102, e.g., disposed at a rear of the device. Thus, in this example the physical surroundings may also be represented 124 in the user interface output by the virtual transparency module 120, further discussion of which may be found in relation to FIGS. 5-8.

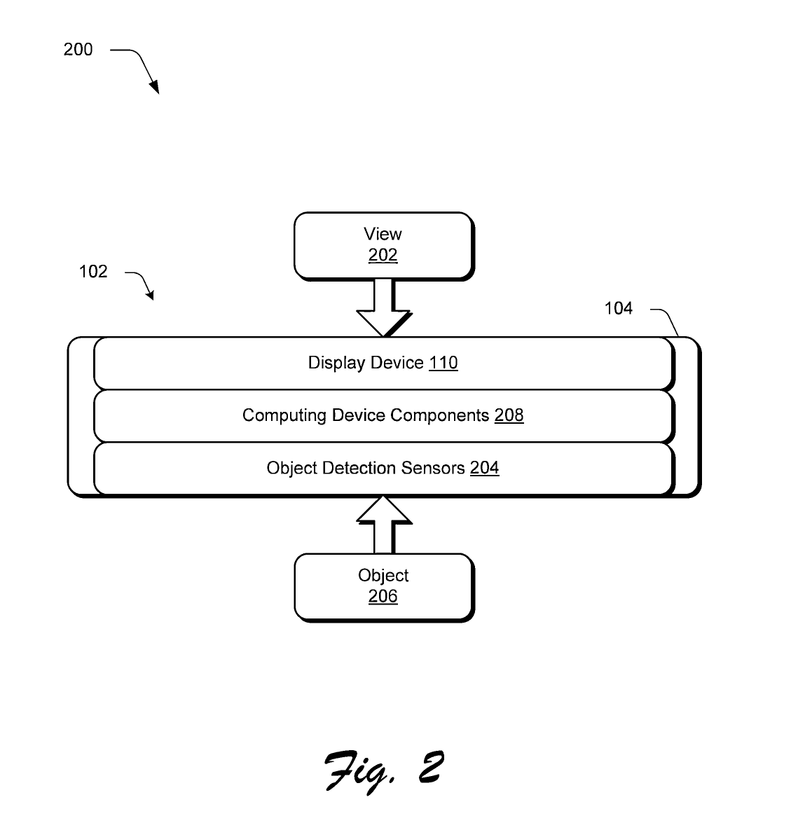

FIG. 2 depicts a system 200 in an example implementation showing a computing device 102 of FIG. 1 in greater detail as including sensors 118 configured to detect proximity of an object. The system 200 of FIG. 2 is illustrated in a cross section view in which a display device 110 is secured to a housing 104 (e.g., directly or indirectly) and viewable 202 via a first side of the housing 104 of the computing device.

Sensors 118 of FIG. 1 are configured as object detection sensors 204 in this example that are disposed on a second side of the housing 104 that generally opposes the first side of the housing 104 via which the display device 110 if viewable 202. The object detection sensors 204 are configured to detect proximity of an object 206, such as one or more fingers of the user's hands 106, 108 of FIG. 1, to the sensors and/or second side of the housing 104.

The object detection sensors 204 may be configured in a variety of ways, such as sensors that are configured to detect contact, proximity of an object that does not involve contact, and so on. Examples of such sensor configurations include capacitive sensors, sensor-in-pixel configurations, strain sensors, resistive sensors, an optical wedge as shown and described in relation to FIG. 6, one or more cameras, and so forth.

As previously described, the detection of the object 206 by the object detection sensors 204 may be utilized to generate and output a representation of the object 206 by the virtual transparency module 120 for display by the display device 110. The generation and output may be performed in real time to provide feedback to a user on the display device regarding “where” the user's fingers are located. In this way, a virtual transparent display may be output by the display device 110 yet support a relatively small form factor by “hiding” computing device components 208 (e.g., a processing system, memory, network connection device, etc.) and even the object detect sensors 204 themselves as opposed to use of a visually transparent display device 110, which therefore would involve placement of the computing device components “outside” a display area of a display device.

FIGS. 3 and 4 depict example implementations 300, 400 of a user interface output by a display device that includes user interface elements and representations of objects detected by the object detection sensors 204 of FIG. 2. In the example implementation 300 of FIG. 3, a user interface is illustrated as being output by a display device 110 of the computing device 102.

The user interface in this example includes a variety of different user interfaces elements, which include a window into which text is to be entered as well as a representation of functions that are executable through interaction with a rear of the computing device 102. The illustrated representation is a split keyboard having left and right portions that are configured to support interaction with the left and right hands 106, 108 of the user, respectively, although other representations of functions are also contemplated.

The user interface also includes representations of objects detected by the object detection sensors 204 of FIG. 2, which include fingers of the user's right and left hands 106, 108. Thus, the representations of the objects may provide feedback that follows movement of the right and left hands 106, 108 of the user.

The representations in the illustrated implementation 300 are output in a semi-transparent manner that overlaps user interface elements (e.g., the keys of the keyboard) at a corresponding location and proportion that are also displayed as semi-transparent by the display device 110. Thus, a virtual transparent display is provided in which users are given a sense that they are “looking through” the display device 110 to view their fingers. Typing from the back is now intuitive and natural to the user as opposed to conventional techniques in which feedback was not support. A variety of other examples are also contemplated, such as to configure the representations to include solely images of a user's hand, fingertip locations, and so on.

Another example of a user interface is illustrated as part of the example implementation 400 of FIG. 4. In this example, user interface elements include game pieces that may support user interaction detected through use of the object detection sensors 204 of FIG. 2. Thus, a user may “play the game” through interaction with a rear of the computing device 102 without interfering with a display of the game itself. In this way, the user interface may support display of the game without interference from display of representation of inputs, although that implementation is also contemplated as described above. The sensors 118 may also support representation of a physical environment 112 as part of a virtual transparent display as further described below and shown in corresponding figures.

FIG. 5 depicts a system 500 in an example implementation showing a computing device 102 of FIG. 1 in greater detail as including sensors 118 configured to detect a physical environment of the computing device 102. As before, the system 500 of FIG. 2 is illustrated in a cross-section view in which a display device 110 is secured to a housing 104 (e.g., directly or indirectly) and viewable 202 via a first side of the housing 104 of the computing device.

The system 500 also includes sensors 118 of FIG. 1 that are configured as object detection sensors 204 in this example that are disposed on a second side of the housing 104 that generally opposes the first side of the housing 104 via which the display device 110 if viewable 202. The computing device 102 also includes an object detection sensor 502 that is configured to detect proximity of an object to the display device 110, e.g., touchscreen functionality. The object detection sensors 204 are configured to detect proximity of an object 206, such as one or more fingers of the user's hands 106, 108 of FIG. 1, to the sensors and/or second side of the housing 104.

The computing device 102 also includes sensors 118 of FIG. 1 that are configured to detect a physical environment 112 of the computing device 102. This may be performed in a variety of ways, such as through configuration of the environment detection sensor 504 as an image capture system to capture images of the physical environment 112, e.g., act as a color imager. An example of an image capture system is described below and shown in a corresponding figure.

FIG. 6 depicts an example image capture system 600 that includes an optical wedge and that is configured to detect a physical environment 112 of FIG. 1 of the computing device 102. The image capture 600 includes at least one optical wedge 602 in this example that is configured to capture images via an outer surface 604. The images, for instance, may be received via the outer surface 604 and transmitted through the optical wedge 602 and captured by one or more image capture devices, e.g., cameras. Additionally, the optical wedge 602 may be configured as a “zero gap” wedge such that an image may be captured even when an object contacts the outer surface 604.

Thus, in one or more implementations the image capture system 600 may operate as object detection sensors 204 to detect objects (e.g., to support gestures) as well as environment detection sensors 504 to detect the physical environment 112 in which the computing device 102 is disposed. The optical wedge 602, for instance, may be configured to detect an area disposed at a rear of the computing device 102 that corresponds, approximately, to a display area of the display device 110 of FIG. 1. Images so captured may then be utilized to generate representations of the physical environment for display on the display device 110 as previously described in relation to FIG. 1.

In another example, the image capture system 600 is configured to implement the environment detection sensors 504 and other configurations of sensors 118 are utilized to implement the object detection sensors 204, such as through configuration of capacitive sensors using a transparent grid of ITO. A variety of other configurations are also contemplated to detect a physical environment 112, such as a structured-light system or time-of-flight camera to detect depth of objects in the physical environment 112.

The physical environment 112 of FIG. 1 detected by the environment detection sensors 504, regardless of how implemented, may then be processed by the virtual transparency module 120 to generate a virtual transparent display for output by the display device 110. The virtual transparent display in this example includes representations of the physical environment in a user interface, which may be included with representations of objects that are detected as proximal to the object detection sensors 204 of FIG. 5. An example of this is described as follows and shown in a corresponding figure.

FIG. 7 depicts an example implementation 700 in which a user interface displayed by a display device 110 of a computing device 102 includes representations of objects detected as proximal to the computing device 102 as well as representations of the physical environment 112 that includes the computing device. The display device 110 is illustrated as outputting a variety of different user interface elements. This may include a word processing window that is configured to support interaction via a front or rear of the computing device, e.g., through touchscreen functionality of the display device 110 and/or sensors 118 disposed on a back side of the computing device 102. In another example, a split keyboard having first and second portions 704, 706 is displayed in a manner which indicates functions available via input entered solely via a backside of the computing device 102, e.g., through use of a partially transparent display or alteration of other display characteristics. Other user interface elements are also contemplated, such as user interface elements that solely support interaction via the display device 110, and so on.

The user interface also includes representations of objects disposed at the rear of the computing device. For example, a representation 708 is illustrated in phantom to depict a detected object, which is a finger of a user's hand 106 in this instance. A representation 710 is also included that depicts the physical environment 112 in which the computing device 102 is disposed. As illustrated, the representation 710 includes trees that are included in the physical environment and displayed in a background of a user interface.

The virtual transparency module 120 may be configured to co-register the displayed user interface elements along with the detected objects and physical environment such that the user interface elements appear as displayed on a transparent window. Further, this display may be performed in real time to follow movement of the computing device 102 and objects and thus update the display on the display device 110 accordingly, e.g., using an output protocol to bypass a software driver associated conventionally with the object detection sensors 204 and through use of stream using DirectX® APIs. In this way, a user may type using each of their fingers with minimal interruption to the user interface displayed on the display device 110 in a seamless and non-jarring experience. Although the previous examples described use of the virtual transparent display techniques by a mobile computing device, non-mobile examples are also contemplated as further described below and shown in a corresponding figure.

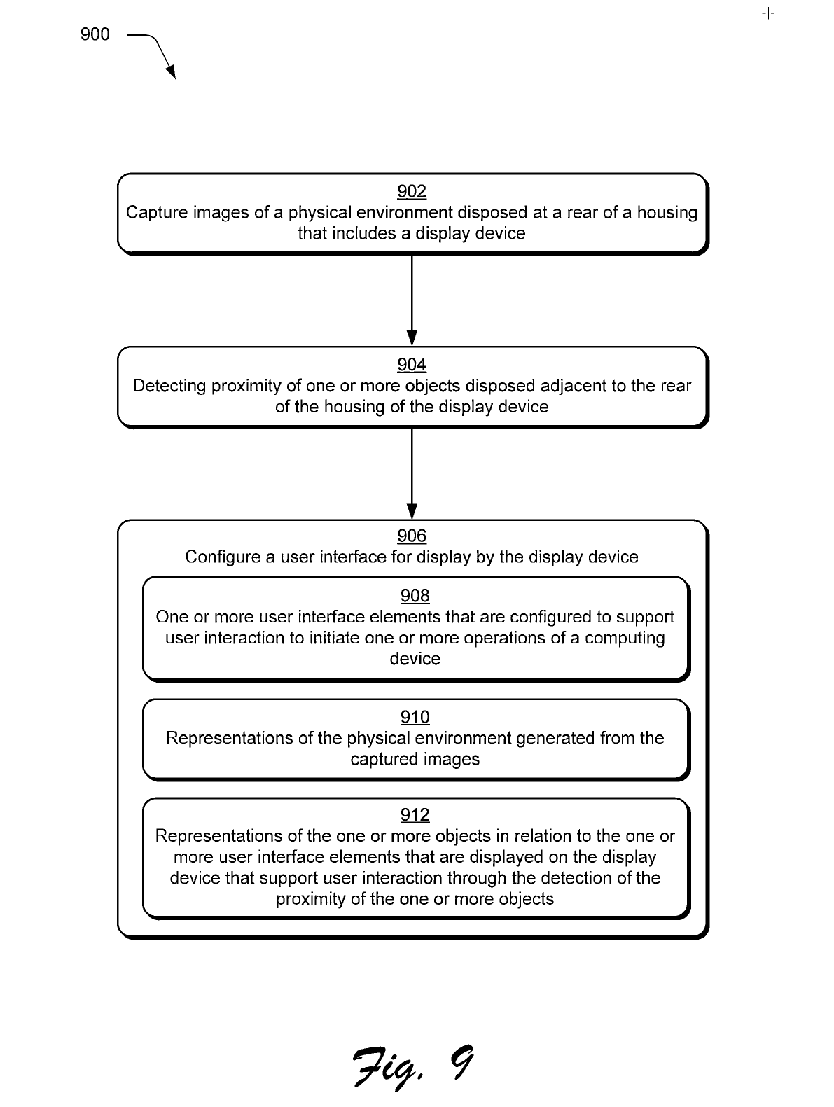

FIG. 8 depicts an example implementation 800 showing the display device 110 of FIG. 1 as being configured to rest on a surface horizontally. The display device 110 in this example is illustrated as incorporated within a housing 802 that is configured to rest on a surface, such as a desktop, table top, and so forth for use in a computer configuration as further described in relation to FIG. 10.

As before, a virtual transparency module 120 of FIG. 1 (e.g., implemented using the desktop PC or as part of the display device 110 in an integrated example) may be utilized to display a virtual transparent display. In the illustrated example, the display device 110 is illustrated as supporting the virtual transparent display and configured within the housing 902 such that the physical surroundings are viewable through the display device 110, such as a portion of a desktop computing device as illustrated. Other implementations are also contemplated, such as implementations in which the physical surroundings are not viewable through the display device 110 although particular objects are (e.g., objects within a defined range, contacting the device, identified as finger, and so on), are viewable in a controllable manner as described in relation to FIGS. 3 and 4, and so on. Other implementations of the display device 110 within the housing are also contemplated, such as a television implementation in which the housing is configured to be mounted to a vertical surface, an example of which is further described in relation to FIG. 10.

Example Procedures

The following discussion describes virtual transparent display techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment and example systems of FIGS. 1-8.

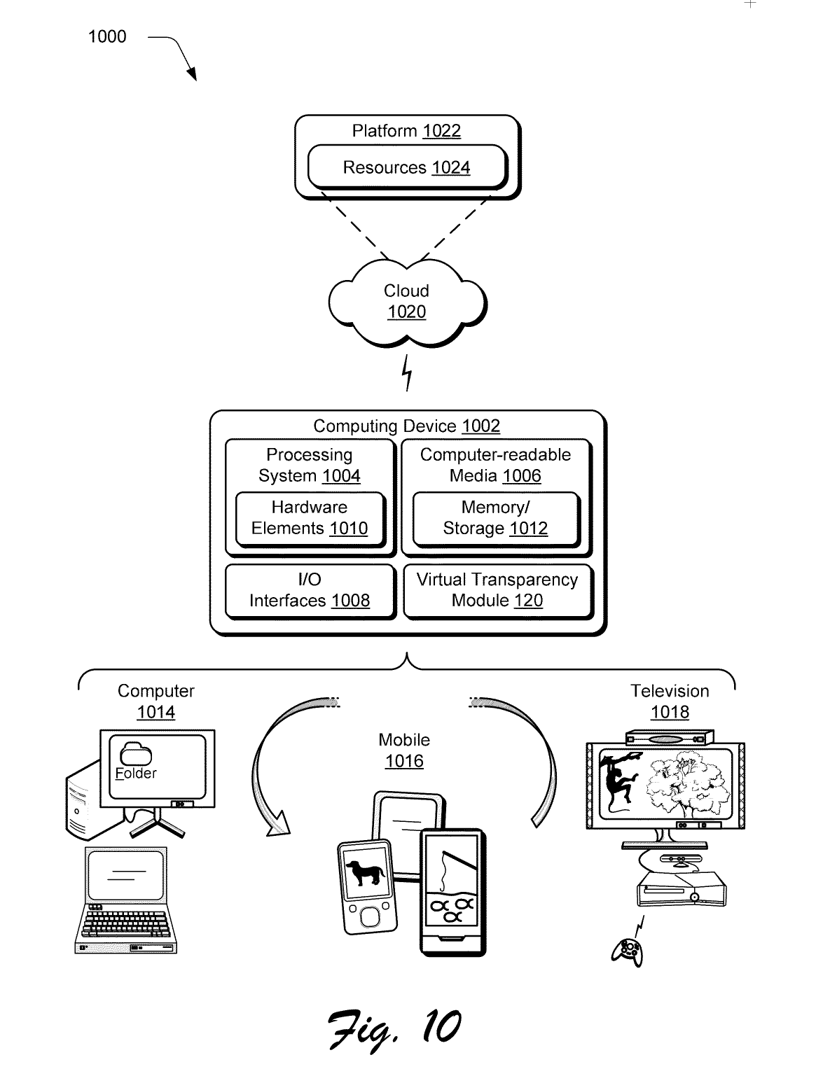

FIG. 9 depicts a procedure 900 in an example implementation in which a virtual transparent display is generated that includes user interface elements, a representation of an object detected as proximal to a display device, and a representation of a physical environment, in which, the display device is disposed. Images are captured of a physical environment that is disposed at a rear of a housing that includes a display device (block 902). The images may be captured by an image capture system, for instance, which may include an optical wedge that supports capture of images of objects that are in contact with a surface of the wedge as well as other objects that are not in contact, e.g., a user's palm, objects in a physical environment 112, and so on.

Proximity is detected of one or more objects disposed adjacent to the rear of the housing of the display device (block 904). The proximity, for instance, may be detected using capacitive sensors, examination of the images captured by the image capture system, and so on.

A user interface is configured (block 906). This configuration may be performed such that the user interface includes one or more user interface elements that are configured to support user interaction to initiate one or more operations of a computing device (block 908). The user interface may also include representations of the physical environment generated from the captured images (block 910). The user interface may further include representations of the one or more object in relation to the one or more user interface elements that are displayed on the display device that support user interaction through the detection of the proximity of the one or more objects (block 912). A variety of other examples are also contemplated without departing from the spirit and scope thereof.

Example System and Device

FIG. 10 illustrates an example system generally at 1000 that includes an example computing device 1002 that is representative of one or more computing systems and/or devices that may implement the various techniques described herein. The computing device 1002 may be, for example, a server of a service provider, a device associated with a client (e.g., a client device), an on-chip system, and/or any other suitable computing device or computing system. Further, the computing device 1002 includes a virtual transparency module 120.

The example computing device 1002 as illustrated includes a processing system 1004, one or more computer-readable media 1006, and one or more I/O interface 1008 that are communicatively coupled, one to another. Although not shown, the computing device 1002 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1004 is representative of functionality to perform one or more operations using hardware. Accordingly, the processing system 1004 is illustrated as including hardware element 1010 that may be configured as processors, functional blocks, and so forth. This may include implementation in hardware as an application specific integrated circuit or other logic device formed using one or more semiconductors. The hardware elements 1010 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 1006 is illustrated as including memory/storage 1012. The memory/storage 1012 represents memory/storage capacity associated with one or more computer-readable media. The memory/storage component 1010 may include volatile media (such as random access memory (RAM)) and/or nonvolatile media (such as read only memory (ROM), Flash memory, optical disks, magnetic disks, and so forth). The memory/storage component 1010 may include fixed media (e.g., RAM, ROM, a fixed hard drive, and so on) as well as removable media (e.g., Flash memory, a removable hard drive, an optical disc, and so forth). The computer-readable media 1006 may be configured in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1002 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1002. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1002, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 and computer-readable media 1006 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1010. The computing device 1002 may be configured to implement particular instructions and/or functions corresponding to the software and/or hardware modules. Accordingly, implementation of a module that is executable by the computing device 1002 as software may be achieved at least partially in hardware, e.g., through use of computer-readable storage media and/or hardware elements 1010 of the processing system 1004. The instructions and/or functions may be executable/operable by one or more articles of manufacture (for example, one or more computing devices 1002 and/or processing systems 1004) to implement techniques, modules, and examples described herein.

As further illustrated in FIG. 10, the example system 1000 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 1000, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 1002 may assume a variety of different configurations, such as for computer 1014, mobile 1016, and television 1018 uses. Each of these configurations includes devices that may have generally different constructs and capabilities, and thus the computing device 1002 may be configured according to one or more of the different device classes and accordingly the display device 110 may also be configured to accommodate these different configurations. For instance, the computing device 1002 may be implemented as the computer 1014 class of a device that includes a personal computer, desktop computer, a multi-screen computer, laptop computer, netbook, and so on.

The computing device 1002 may also be implemented as the mobile 1016 class of device that includes mobile devices, such as a mobile phone, portable music player, portable gaming device, a tablet computer, a multi-screen computer, and so on. The computing device 1002 may also be implemented as the television 1018 class of device that includes devices having or connected to generally larger screens in casual viewing environments. These devices include televisions, set-top boxes, gaming consoles, and so on.

The techniques described herein may be supported by these various configurations of the computing device 1002 and are not limited to the specific examples of the techniques described herein. This functionality may also be implemented all or in part through use of a distributed system, such as over a “cloud” 1020 via a platform 1022 as described below.

The cloud 1020 includes and/or is representative of a platform 1022 for resources 1024. The platform 1022 abstracts underlying functionality of hardware (e.g., servers) and software resources of the cloud 1020. The resources 1024 may include applications and/or data that can be utilized while computer processing is executed on servers that are remote from the computing device 1002. Resources 1024 can also include services provided over the Internet and/or through a subscriber network, such as a cellular or Wi-Fi network.

The platform 1022 may abstract resources and functions to connect the computing device 1002 with other computing devices. The platform 1022 may also serve to abstract scaling of resources to provide a corresponding level of scale to encountered demand for the resources 1024 that are implemented via the platform 1022. Accordingly, in an interconnected device embodiment, implementation of functionality described herein may be distributed throughout the system 1000. For example, the functionality may be implemented in part on the computing device 1002 as well as via the platform 1022 that abstracts the functionality of the cloud 1020.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. An apparatus comprising:
a housing;
a display device viewable by and secured to a first side of the housing;
one or more sensors configured to detect proximity of an object to a second side of the housing that is opposite to the first side of the housing; and
one or more modules implemented at least partially in hardware, the one or more modules configured to cause output of a representation on the display device of the object detected by the one or more sensors.

2. An apparatus as described in claim 1, wherein the one or more sensors include object detection sensors that are configured to detect the proximity of the object.

3. An apparatus as described in claim 2, wherein the object detection sensors include capacitive sensors.

4. An apparatus as described in claim 1, wherein:
the one or more sensors include environment detection sensors that are also configured to detect an environment disposed at the second side of the housing; and
the one or more modules are configured to process an output of the environment detection sensors to configure a user interface displayed by the display device to include a physical representation of the environment.

5. An apparatus as described in claim 4, wherein the environment detection sensors are configured to capture images of the environment and the one or more modules are configured to configure the user interface to output the images as the physical representation of the environment.

6. An apparatus as described in claim 4, wherein the output of the physical representation of the environment in the user interface causes a corresponding portion of the display device to be viewable as a virtual transparent display.

7. An apparatus as described in claim 6, wherein the one or more modules are configured to update the physical representation in real time.

8. An apparatus as described in claim 4, wherein the environment detection sensors are configured as a color imager.

9. An apparatus as described in claim 4, wherein the environment detection sensors are configured to include an optical wedge to capture images of the environment.

10. An apparatus as described in claim 1, wherein the housing is configured according to a hand held form factor configured to be held by one or more hands of a user and the one or more modules are disposed within the housing.

11. A method comprising:
capturing images of a physical environment disposed at a rear of a housing that includes a display device;
detecting proximity of one or more objects disposed adjacent to the rear of the housing of the display device; and
configuring a user interface for display by the display device, the user interface including:
one or more user interface elements that are configured to support user interaction to initiate one or more operations of a computing device;
representations of the physical environment generated from the captured images; and
representations of the one or more objects in relation to the one or more user interface elements that are displayed on the display device that support user interaction through the detection of the proximity of the one or more objects.

12. A method as described in claim 11, wherein the representations of the physical environment and the representations of the one or more objects are configured for display by the display device in real time.

13. A method as described in claim 12, wherein the real time display is performed to give an appearance that the display device is a transparent window that includes the one or more user interface elements.

14. A method as described in claim 11, wherein the detecting of the one or more objects is performed using images captured through use of an optical wedge.

15. A method as described in claim 11, wherein the capturing of the one or more images is performed through use of an optical wedge.

16. An apparatus comprising:
a housing;
a display device viewable by and secured to a first side of the housing;
an image capture system including an optical wedge configured to capture images of a physical environment disposed on a second side of the housing that opposes the first side of the housing; and
one or more modules implemented at least partially in hardware, the one or more modules configured to cause output of a virtual transparent display on the display device that includes:
one or more user interface elements that are configured to support user interaction to initiate one or more operations of a computing device; and
a representation of the physical environment generated form the captured images.

17. An apparatus as described in claim 16, wherein the one or more modules are further configured to generate the virtual transparent display to include a representation of one or more fingers of a user's hand when disposed adjacent to the second side of the housing.

18. An apparatus as described in claim 16, wherein the one or more modules are also configured to detect proximity of an object to the second side of the housing, the detected proximity supporting user interaction with the one or more user interface elements displayed by the display device.

19. An apparatus as described in claim 18, wherein the detection of the proximity is performed using one or more images captured by the image capture system.

20. An apparatus as described in claim 18, wherein the detection of the proximity is performed using one or more sensors that are not part of the image capture system.
